(19) United States
(12) Patent Application Publication
(10) Pub. No.: US 2015/0239138 A1
(43) Pub. Date: Aug. 27, 2015

(54) Self-contained Shaving System

(71) Applicants: Steven M. Kurzet, Southern Pines, NC (US); John Frederick Higdon, Matthews, NC (US); Julie Christine Howell, Indian Trail, NC (US)

(72) Inventors: Steven M. Kurzet, Southern Pines, NC (US); John Frederick Higdon, Matthews, NC (US); Julie Christine Howell, Indian Trail, NC (US)

(21) Appl. No.: 14/186,671

(22) Filed: Feb. 21, 2014

(51) Int. Cl. B26B 21/44; B26B 21/52

(52) U.S. Cl. CPC B26B 21/446; B26B 21/52

(57) ABSTRACT

A self-contained shaving system provides a handle having a razor and an internal reservoir containing a shaving fluid, such as shaving cream, and dispenses shaving fluid without the need for internal pressurization of the reservoir.

### FIELD OF THE INVENTION

The invention pertains to disposable razors.

### BACKGROUND OF THE INVENTION

Disposable razors have been widely used as a matter of convenience and sanitation. Due to such concerns, electric razors are impractical. Thus, the practical choice in such environments is a bladed razor.

Use of such razors requires the use of a lubricating agent, such as shaving cream. However, this requirement imposes an additional logistical requirement, providing a container of shaving cream or other lubricating agent to the user along with the razor.

Several attempts have been made to integrate a container of lubricating agent into a razor, thus eliminating the need to provide a separate container. For example, U.S. Pat. No. 2,327,192 to Keene (“the '192 patent) discloses a safety razor with a reservoir for shaving soap in the handle. The '192 patent contemplates that the user would use a pump integrated to the handle to force air pressure around the collapsible shaving soap reservoir, then use a valve to release shaving soap through a tube to the head of the razor. The described device requires multiple moving parts and valves to function, making it expensive to manufacture and subject to damage if dropped. Further, the mechanism offers multiple failure points, such as valve seals that are subject to wear.

Similarly, U.S. Pat. No. 5,070,611 to Derin, et al. (“the '611 patent”) discloses a razor with an aerosol reservoir of shaving cream in the handle. Although aerosol dispensers are well known, the device of the '611 patent requires a mechanism that must be set to prevent accidental triggering of the aerosol container, and which could be accidentally moved to the “active” position while the razor was being used to shave.

U.S. Pat. No. 7,121,754 to Bressler, et al. (“the '754 patent”) discloses a device in which movement of the razor cartridge itself actuates a valve to dispense shaving cream or another shaving material. This device dispenses shaving material through the face of the razor, and has the disadvantage that the surface being shaved (such as one's face) would be in contact with the razor blade before the shaving material is dispensed.

United States Published Patent Application No. 2010/0095529 discloses a razor containing a collapsible reservoir in the handle, and utilizes a suction device to pull shaving material from the reservoir. As with the '754 patent, this device dispenses shaving material at the razor end of the device, creating, if not a danger to the user, the likely result of discomfort during use.

The number of attempts to create a razor/shaving material combination reflect a long-felt need for a successful version of such a device. However, due to complexity and hazards in their use, none of these devices has been commercially successful. Accordingly, it is desirable to provide a combination razor and shaving material dispenser that is economical, safe, and easy to use.

It is further desirable to provide such a combination that is disposable, rather than refillable, to reduce the number of parts and increase the ease of assembly, thus reducing the cost of the device.

Because this device will be preferentially disposable, it may be additionally desirable to construct it from bio-degradable materials, such as, for example, polypropylene, so that, once used, it will not pose a burden on the environment.

### SUMMARY OF THE INVENTION

The invention is a razor that has within its handle a reservoir containing shaving cream or another suitable shaving lubricant. Because the razor of the present invention is intended to be disposable, the reservoir in the preferred embodiment is not refillable. However, those of skill in the art will recognize that a means for refilling the reservoir, such as an injection port, could be provided without departing from the spirit of the invention. Such a means is not desirable because it would add complexity and expense to the device.

The invention further comprises a pump that operates without the need for the shaving lubricant reservoir to be pressurized. When the pump is actuated, shaving cream is withdrawn from the pump. When the pump is released, a following piston at the opposite end of the reservoir is forced inward by outside air pressure. As a result, the pump provides an efficient delivery system for the shaving lubricant without the need for aerosols or other pressurization of the reservoir.

In a preferred embodiment, shaving lubricant is dispensed from the pump at the end of the handle opposite the razor blade or blades, thus insuring that the user's hands are not subject to being cut accidentally while dispensing the shaving lubricant. A removable cap is provided to fit over the base of the handle and protect the pump from being accidentally actuated.

### BRIEF DESCRIPTION OF THE DRAWINGS

FIG. 1 is an exploded view of one embodiment of the razor of the present invention.

FIG. 2 is a sectional view of the razor.

FIG. 3A is a side view of a pump suitable for use with the present invention.

FIG. 3B is a sectional view of the pump of FIG. 3A along line A-A′.

### DETAILED DESCRIPTION

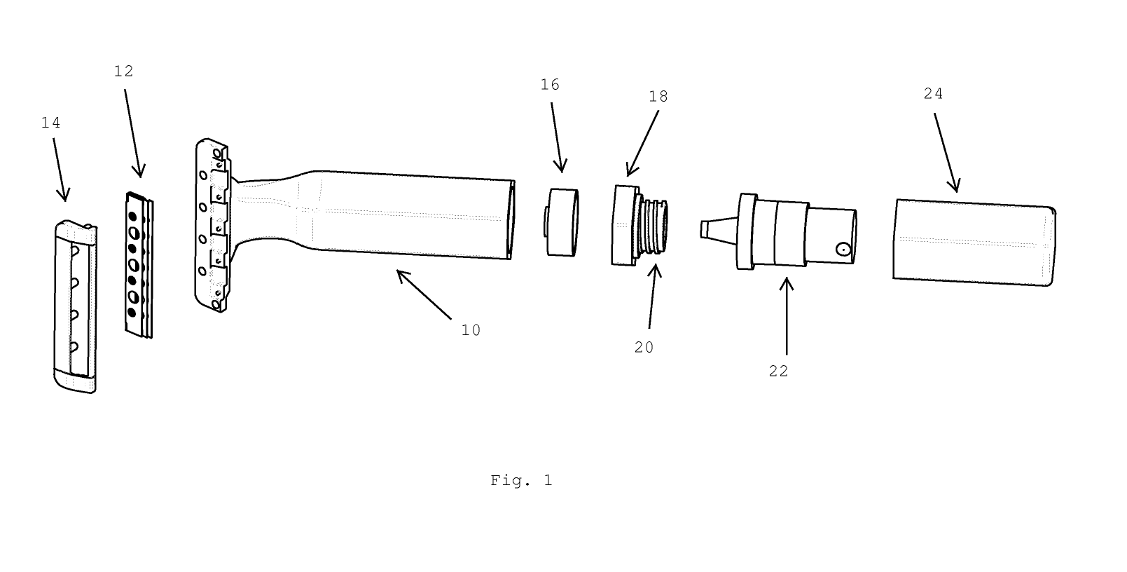

Referring to FIG. 1, an exploded view of a razor of the present invention is shown. The razor comprises an at least partially hollow body 10, one or more razor blades 12, and a blade holder 14. Piston 16 is insertable into the hollow portion of the handle, and seals one end of the shaving lubricant reservoir. Bottle end cap 18 comprises a threaded connector 20, onto which pump 22 is threadably attachable. Removable protective cap 24 covers pump 22 when pump 22 is not in use, preventing accidental actuation of pump 22.

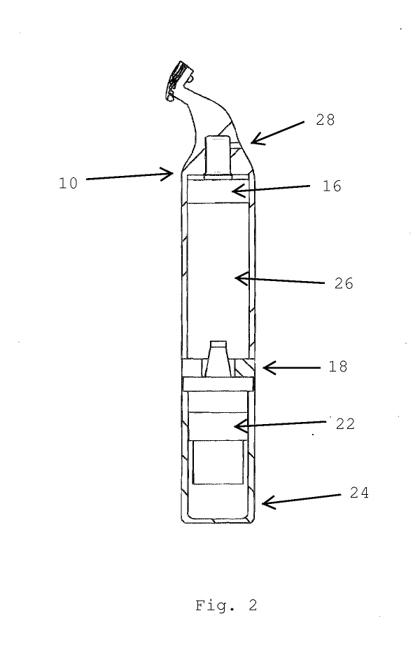

Referring to FIG. 2, the assemble razor is shown in cross section. Shaving fluid reservoir 26, which is preferably cylindrical, is sealed at one end by piston 16, and at the other by the combination of bottle end cap 18 and pump 22. (Those of skill in the art will recognize that the internal form of shaving fluid reservoir 26 may be any form, such as triangular, pentagonal, etc., so long as a matching piston can be provided that provides a sealing relationship with the inside walls of the reservoir. Further, the outside shape of the body 10 is solely a matter of preference and what is comfortable for the user.) Removable protective cap 24 is in place, preventing accidental actuation of pump 22. Port 28 allows outside air into body 10. Thus, when pump 22 is actuated and shaving fluid is withdrawn from shaving fluid reservoir 26, the pressure of outside air entering through port 28 forces piston 16 to move toward bottle end cap 18, reducing the net remaining effective volume of shaving fluid reservoir 26 to that of the remaining shaving fluid. In other words, movement of the piston substantially reduces the effective volume of the reservoir by the volume of the amount of fluid pumped out. This process continues until the supply of shaving fluid is effectively exhausted.

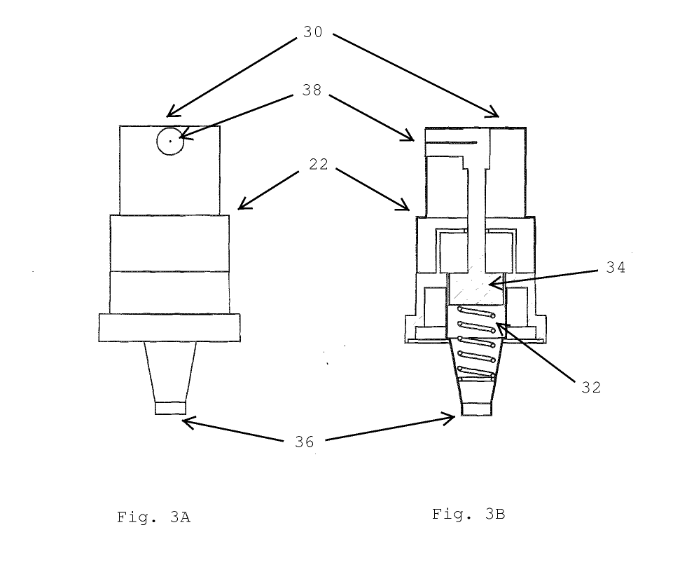

Referring now to FIGS. 3A and 3B, a pump 22 suitable for use with the present invention is seen in both side and sectional views. Pump 22 is actuated by pressing on pump stem 30, compressing return spring 32. When the pressure on pump stem 30 is relaxed, return spring 32 expands, withdrawing fluid from the shaving fluid reservoir 26 (FIG. 2) by drawing or pushing it into pump chamber 34 via pump inlet 36. Repeated pressing of pump stem 30 will continue to draw more shaving fluid from shaving fluid reservoir 26, forcing fluid through pump stem 30 to pump outlet 38. When a sufficient amount of fluid has been dispensed, the user may then return removable protective cap 24 (FIG. 2) to position to prevent accidental activation of pump 22.

Those of skill in the art will recognize that variations on the above description can be made without departing from the spirit of the invention, and that the above description is made generally and is not intended to limit the scope of the invention.

We claim:

1. A shaving system comprising a handle, a razor blade attached to said handle and positioned for use in shaving, a shaving fluid reservoir within said handle containing shaving fluid, and a pump, in fluid communication with said reservoir, comprising an outlet for dispensing shaving fluid from said pump, and a pump stem, wherein said shaving fluid in said reservoir is unpressurized and wherein repeated pressing of said pump stem withdraws shaving fluid from said reservoir through said pump to said pump outlet.

2. The shaving system of claim 1, wherein said reservoir is cylindrical and comprises a piston in sealing relationship with the inner walls of said reservoir, and wherein removal of shaving fluid from said reservoir results in said piston moving toward said pump.

3. The shaving system of claim 2, wherein movement of said piston reduces the effective volume of said reservoir by substantially the volume of shaving fluid removed via said pump.

4. The shaving system of claim 2, wherein said piston comprises an inner side and an outer side, said inner side being in contact with said shaving fluid and said outer side being exposed to atmospheric air pressure.

5. The shaving system of claim 4, additionally comprising a port in fluid communication with atmospheric air pressure outside said handle and with said outer side of said piston.

6. The shaving system of claim 1, wherein the materials used to construct said handle and said pump are substantially bio-degradeable.

7. The shaving system of claim 1, additionally comprising a plurality of razor blades attached to said handle and positioned for use in shaving.

8. The shaving system of claim 1, additionally comprising a selectively removable cap, wherein said cap may be fixed in a position preventing accidently activation of said pump when said pump is not in use.
